(19) United States
(12) Patent Application Publication
(10) Pub. No.: US 2023/0419645 A1
(43) Pub. Date: Dec. 28, 2023

(54) METHODS AND APPARATUS FOR ASSISTED DATA REVIEW FOR ACTIVE LEARNING CYCLES

(71) Applicant: Intel Corporation, Santa Clara, CA (US)

(72) Inventors: Vinnam Kim, Pyeongtaek-si (KR); Wonju Lee, Seongnam-si (KR); Seok-Yong Byun, Seoul (KR)

(21) Appl. No.: 18/457,169

(22) Filed: Aug. 28, 2023

(51) Int. Cl. G06V 10/778; G06V 10/774

(52) U.S. Cl. CPC G06V 10/7788; G06V 10/774

(57) ABSTRACT

Systems, apparatus, articles of manufacture, and methods are disclosed for assisted data review for active learning cycles. An example apparatus includes programmable circuitry to at least one of instantiate or execute the machine readable instructions to: determine a first training loss associated with a first data point of training data for training a machine learning model; determine a second training loss associated with a second data point of the training data; rank the training data based on aggregate statistics of the first and second training losses; select, based on the rank, the first data point for annotation; and modify an existing label of the first data point based on the annotation.

### FIELD OF THE DISCLOSURE

This disclosure relates generally to artificial intelligence and, more particularly, to an artificial intelligence assisted data review for active learning cycles.

### BACKGROUND

The quality of training data used for training a machine learning model significantly affects the model quality. User input on the training data, e.g., high-quality labels of the training data from human viewers, can help a machine learning process generate good quality machine learning model. The process may provide a continuous feedback loop, where the user intervenes (e.g., to review noisy label samples of the training data during an active learning cycle). Such a process may result in improved learning of the artificial intelligence (AI) system and improved output of the AI system.

### BRIEF DESCRIPTION OF THE DRAWINGS

FIG. 1A is a block diagram of a first example environment in which an example data review circuitry operates to assist an artificial intelligence system with data review.

FIG. 1B is a block diagram of a second example environment in which an example data review circuitry operates to assist an artificial intelligence system with data review.

FIG. 2 is a block diagram of an example implementation of the data review circuitry of FIG. 1.

FIG. 3 is a flowchart representative of example machine readable instructions and/or example operations that may be executed, instantiated, and/or performed by example programmable circuitry to implement the data review circuitry of FIG. 1A.

FIG. 4 is a block diagram of an example processing platform including programmable circuitry structured to execute, instantiate, and/or perform the example machine readable instructions and/or perform the example operations of FIG. 3 to implement the data review circuitry of FIG. 1A.

FIG. 5 is a block diagram of an example implementation of the programmable circuitry of FIG. 4.

FIG. 6 is a block diagram of another example implementation of the programmable circuitry of FIG. 4.

FIG. 7 is a block diagram of an example software/firmware/instructions distribution platform (e.g., one or more servers) to distribute software, instructions, and/or firmware (e.g., corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used in herein, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/− 10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Artificial intelligence (AI), including machine learning (ML), deep learning (DL), and/or other artificial machine-driven logic, enables machines (e.g., computers, logic circuits, etc.) to use models to process input data to generate outputs based on patterns and/or associations previously learned by the models via a training process. For instance, a model may be trained with data to recognize patterns and/or associations and follow such patterns and/or associations when processing input data such that other input(s) result in output(s) consistent with the recognized patterns and/or associations.

In general, implementing a ML/AI system involves two phases, a learning/training phase, and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Training is performed using training data. Recent trends in the computing industry include focusing on data quality when implementing artificial intelligence models and systems, as the data quality affects model quality significantly more than the architecture. In supervised learning, labeled data is the designation for data including a label indicating a characteristic, property, classification, or other feature of the data. In real-world scenarios, obtaining high-quality labels can be challenging due to the large volumes of data required, coupled with human labelers being prone to fatigue, errors, and inconsistencies. Labeling is applied to the training data by a user.

Once training is complete, the model is deployed for use as an executable construct that processes an input and provides an output based on the network of nodes and connections defined in the model.

In some examples, during active training cycles, output of a model being trained (e.g., output from training one or more layers of the model) may be captured and provided as feedback. By analyzing the feedback, an accuracy of the model (e.g., a model undergoing training or a deployed model) can be determined. If the feedback indicates that the accuracy of the model is less than a threshold or other criterion, training of an updated model can be triggered using the feedback and an updated training data set, hyperparameters, etc., to generate an updated model.

Methods and apparatus disclosed herein identify and recommend noisy label sample data points to an annotator (e.g., a human reviewer) using model training statistics. Noisy label sample data points are data points that have (or are predicted to have) incorrect labels and non-noisy label sample data points are data points that have (or are predicted to have) accurate labels. The recommended noisy label sample data points are reviewed by the annotator for labeling accuracy and are corrected if they are true positives. In some examples, the noisy label sample points are a subset of the entire training data and compared with existing solutions that include reviewing an entire training data, such disclosed examples provide efficient methods and apparatuses to facilitate model training with improved training data samples.

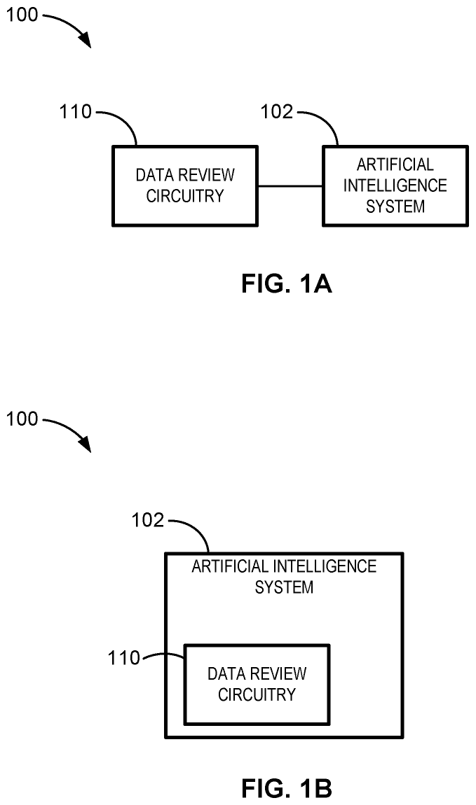

FIG. 1A is a block diagram of an example environment 100 in which an example data review circuitry 110 operates to communicate with an artificial intelligence system 102, to identify noisy label data points, to accumulate a training loss obtained from model training of the AI system 102, to rank the noisy label sample data points, and to interact with an annotator.

The artificial intelligence system 102 of FIG. 1A includes a model that leverages algorithms, data, and advanced computational techniques to process information and learn patterns in the data. The AI system 102 continually improves performance through an iterative learning process. The model in the AI system 102 includes an objective function which has a cost function representing the training loss.

The training loss is a mathematical representation of how well the model is performing on a given task and is used to guide the learning process. For example, the training loss may be a metric that indicates how well the model fits the training data. Thus, the training loss provides an assessment of the error of the model on the training data. The particular training loss function for a given implementation may be selected to capture the error between an expected result and an output from the model trained on the training data in association with the problem to be solved. For example, the loss function may provide a calculation of the distance between a current output of the model (e.g., a result generated by the model for one or more elements of the training data) and an expected output of the model (e.g., for the same one or more elements of the training data). In some implementations, the loss function may be chosen based on characteristics of the classification problem and the characteristics of the selected classifier (e.g., the particular activation function used in a layer of AI system 102). For example, in some implementations where the output of the model is a prediction of a numerical value, a mean squared error (MSE) loss function may be utilized with a linear activation function, a rectified linear activation function, etc. In another implementation where an output of the model is a binary value, a binary cross entropy loss function may be utilized with a sigmoid activation function. The training loss function may include a maximum likelihood estimation, a cross-entropy calculation, etc.

The data review circuitry 110 of FIG. 1A is an example AI assisted data review system that is leveraged by the AI system 102 to integrate with human-in-the-loop for active learning. The data review circuitry 110 has subsystems to store training loss statistics, to analyze the training loss statistics to rank data samples from training data, and to prompt the annotator to review selected data samples based on the ranking.

In operation, the active learning cycle initiates with model training inside the AI system 102. An active sampler, a component or algorithm responsible for selecting the most informative data points, identifies those that significantly reduce the model's uncertainty or quality caused by noisy data samples within the training data. The active sampler in the AI system 102 operates on an unlabeled dataset and presents the data to an annotator. The annotator converts the unlabeled dataset into a labeled one. The labeled dataset is utilized for training, creating a loop known as a human-in-the-loop system. The AI system 102 of FIG. 1A communicates with the data review circuitry 110 to analyze noisy labels within the labeled dataset. The data review circuitry 110 then presents data points with noisy labels back to the annotator for relabeling. The data review circuitry 110 sends the relabeled dataset back to the AI system 102. The process of utilizing the data review circuitry 110 may repeat as many times as necessary to satisfy the objective function of AI system 102.

FIG. 1B is a block diagram of a second environment 150 in which an example data review circuitry 110 is integrated into an artificial intelligence system 152. The example data review circuitry 110 operates to communicate with the AI system 152, to identify data points with noisy labels, to accumulate a training loss obtained from model training of the AI system 152, to rank the noisy label sample data points, and to present noisy label sample data points to an annotator for review.

The artificial intelligence system 102 of FIG. 1B includes a model that leverages algorithms, data, and advanced computational techniques to process information and learn patterns in the data. The AI system 102 continually improves performance through an iterative learning process. The model in the AI system 102 includes an objective function which has a cost function representing the training loss. The training loss is a mathematical representation of how well the model is performing on a given task and is used to guide the learning process.

The data review circuitry 110 of FIG. 1B is an example embedded AI assisted data review system that is integrated into the human-in-the-loop of the active learning cycle for the artificial intelligence system 102 of FIG. 1B. The data review circuitry 110, similar as the data review circuitry 110 illustrated in FIG. 1A, has subsystems to store training loss statistics, to analyze and rank sample data based on the training loss statistics, and to prompt the annotator to review a subset of sample data based on the ranking.

In operation, the active learning cycle initiates with model training inside the AI system 102, which is similar to the operation of the artificial system 102 described above. The AI system 102 of FIG. 1B integrates the data review circuitry 110 to analyze noisy labels within the labeled dataset. It then presents data points with noisy labels back to the annotator for relabeling.

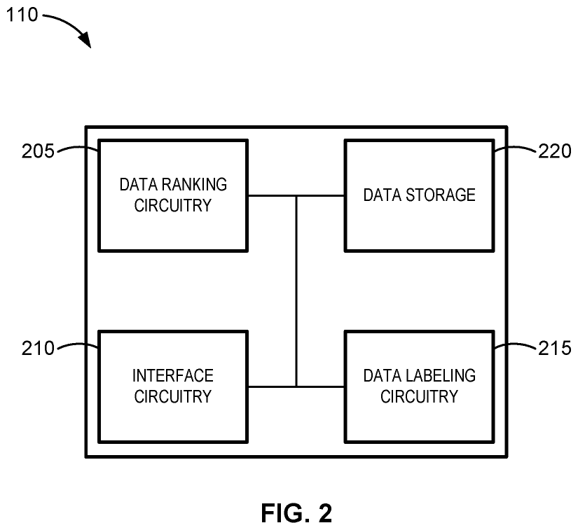

FIG. 2 is a block diagram of an example implementation of the data review circuitry 110 of FIG. 1A and FIG. 1B to recommend samples that the associated labels are noisy for further annotation. The data review circuitry 110 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the data review circuitry 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The data review circuitry 110 includes an example data ranking circuitry 205, an example interface circuitry 210, an example data labeling circuitry 215, and an example data storage 220.

The example data ranking circuitry 205 analyzes the dataset used by the AI system 102 from FIG. 1A and/or FIG. 1B to analyze loss (e.g., utilizing a loss function) and determine ranking of data samples. The example data ranking circuitry 205 utilizes a an exponential moving average (EMA) of an instantaneous loss associated with the AI system 102. A simple EMA is a weighted moving average with exponentially decayed weights for each data point. To describe the loss dynamics using an exponential moving average of the instantaneous loss, the example loss dynamics are defined and computed recursively by the ranking circuitry 205 as: EMAₜ₊₁=γ×L(f(xᵢ; θₜ), yᵢ)+(1−γ)×EMAₜ, where, given a sample (xᵢ, yᵢ) for i∈N, xᵢ represents the features, yᵢ is a label for the sample, N is the number of samples, f(xᵢ, θₜ) denotes an output of the model for the sample, θₜ is the model parameters at step t along the training history, and γ∈[0,1] is a discounting factor. According the illustrated example, EMA is initialized at 0 (e.g., EMA₀=0). Alternatively, any other type of loss function may be utilized, for example, an instantaneous loss may be determined rather than an averaged loss.

To accommodate different minimum units of labeling noise in different model implementations (e.g., computer vision tasks), the training loss may be decomposed into a label-level loss. Different decompositions may be utilized for different model implementations:

For a classification task where the label is an image, no decomposition is utilized and the loss L is simply: L(f(xᵢ; θₜ), yᵢ).

For an object detection task, L(f(xᵢ; θₜ), yᵢ) is decomposed into Σ_{b}_{ⱼ}_{∈γ}_{ᵢ}(L_{cls}(bⱼ)+L_{reg}(bⱼ)) where L_{cls}(bⱼ) is a classification loss for a bounding box label, L_{reg}(bⱼ) is a regression loss to fit the bounding box location, and bⱼ∈yᵢ is a bounding box label. The decomposed L_{cls}(bⱼ) and L_{reg}(bⱼ) are tracked for bⱼ∈yᵢ and i∈N to detect the noise in the class label and position of the bounding box.

For a segmentation task, the training loss is decomposed into a pixel level classification loss by decomposing L(f(xᵢ; θₜ, yᵢ) into Σₚ_{ⱼ}(L_{cls}(Pⱼ)), where Pⱼ is a pixel in the image. In some implementations, pixels that are nearby each other are grouped together using superpixels where

$${L}_{supcls} ( {g}_{j} ) := \frac{1}{\vert {g}_{j} \vert} {\sum }_{{p}_{k} ∈ {g}_{j}} ( {L}_{c l s} ( {p}_{k} ) )$$

for each superpixel gⱼ. Such grouping may be utilized to reduce the amount of memory needed as compared with non-grouped approaches.

After determining loss statistics (e.g., EMA statistics paired with labels from the database), the example data ranking circuitry 205 determines ranks for data points. The example data ranking circuitry 205 determines ranks by sorting the data points according to their associated loss value (e.g., the highest determined loss is the highest determined rank). Once the data points are assigned ranks a subset of the data points is selected for annotation (e.g., provided to a reviewer such as a human reviewer) to determine if the labels are to be corrected (e.g., the reviewer may review and apply corrected labels and/or may determine that a candidate for review is a false positive for review (e.g., is already correctly labeled)). The example data ranking circuitry selects a fixed number of data points for review (e.g., 10 data points may be selected during each analysis). Alternatively, data points may be selected based on a threshold loss value, a percentage of the total data points used during training, a random number, etc.

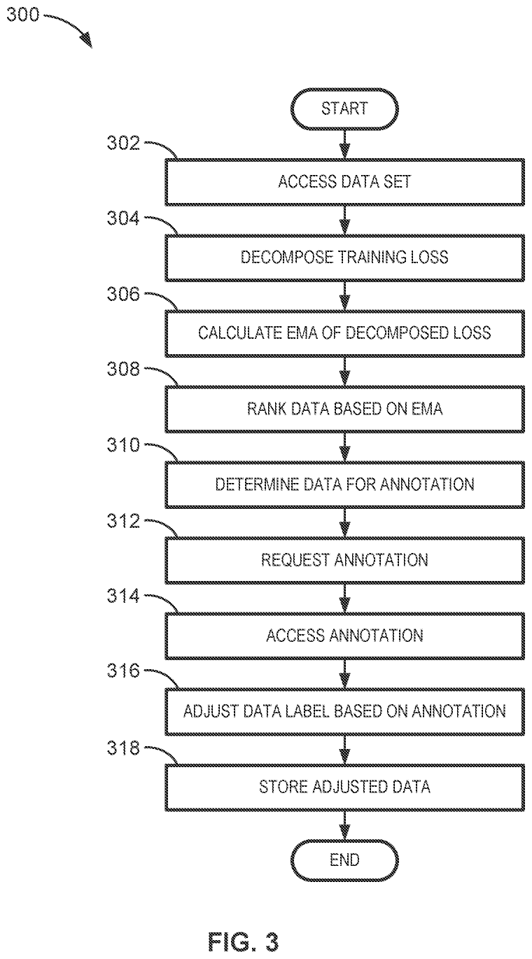

In some examples, the data ranking circuitry 205 is instantiated by programmable circuitry executing data review instructions and/or configured to perform operations such as those represented by the flowchart(s) of FIG. 3.

As mentioned above, the first training loss and second training loss are used to calculate aggregate statistics of the first and second data points, which then subsequently enables ranking of the data points based on the aggregate statistics. Based on the ranking of the data points, in one embodiment, a first data point for annotation is selected. The ranking ceases when there are no more data points selected (e.g., there are no more data points labeled as noisy).

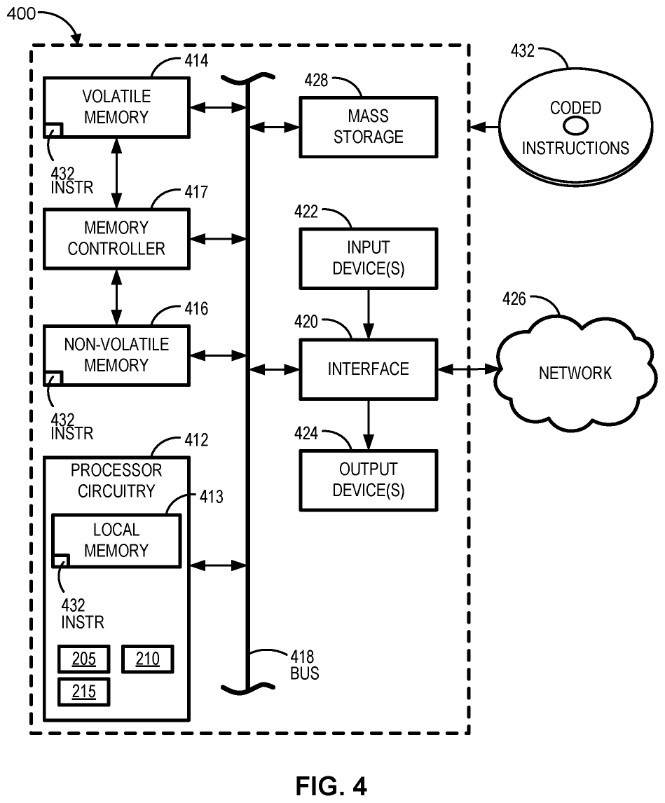

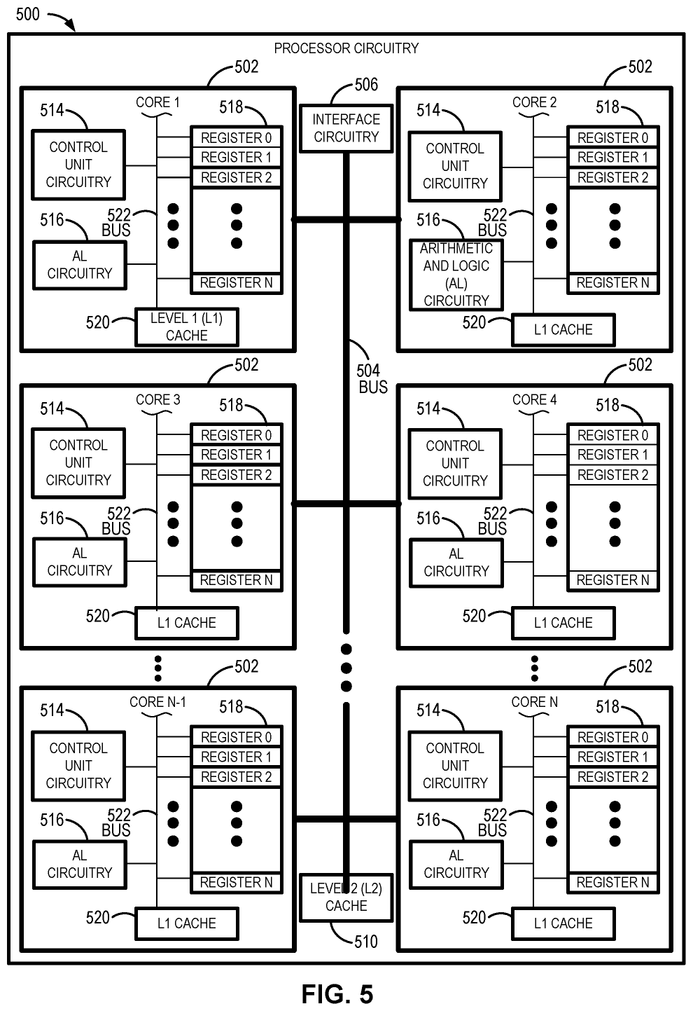

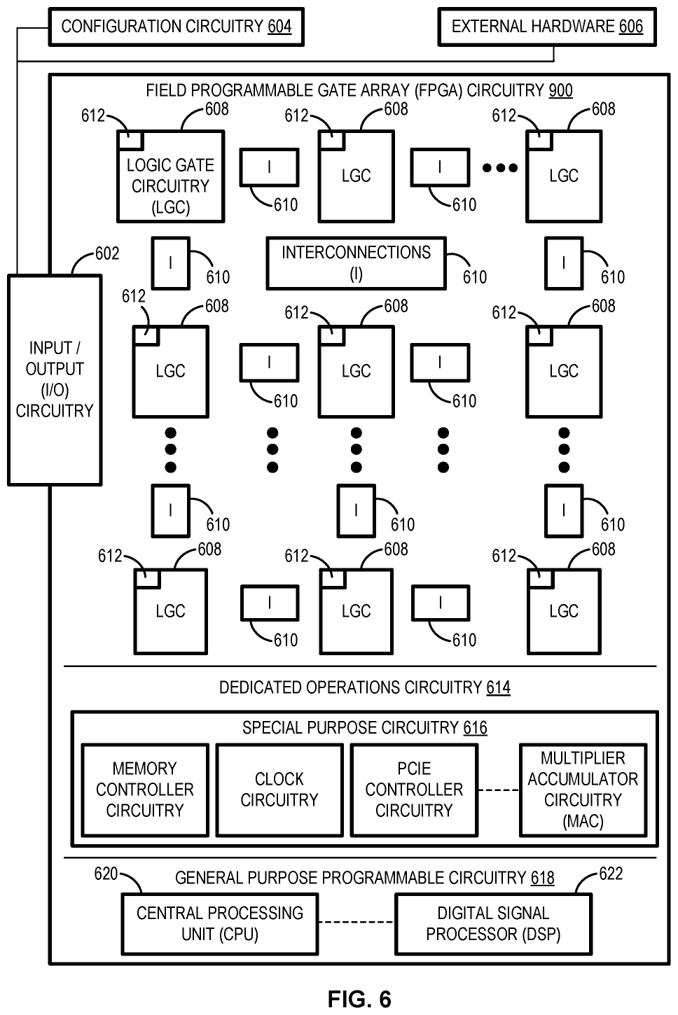

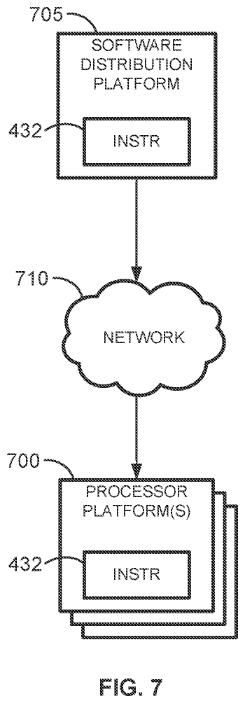

In some examples, the data ranking circuitry 205 includes means for statistical ranking. For example, the means for statistical ranking may be implemented by data ranking circuitry 205. In some examples, the data ranking circuitry 205 may be instantiated by programmable circuitry such as the example programmable circuitry 412 of FIG. 4. For instance, the data ranking circuitry 205 may be instantiated by the example microprocessor 500 of FIG. 5 executing machine executable instructions such as those implemented by at least blocks 702, 704 of FIG. 7. In some examples data ranking circuitry 205 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the data ranking circuitry 205 may be instantiated by any other combination of hardware, software, and/or firmware. For example, the data ranking circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the data ranking circuitry 205 of FIG. 2 is illustrated in FIG. 1, one or more of the elements, processes, and/or devices illustrated in FIG. 1 may be combined, divided, re-arranged, omitted, eliminated, and/or implemented in any other way. Further, the example data ranking circuitry 205, the example interface circuitry 210, the example data labeling circuitry 215, and the example data storage 220, and/or, more generally, the example data labeling circuitry 215 of FIG. 2, may be implemented by hardware alone or by hardware in combination with software and/or firmware. Thus, for example, any of the example data ranking circuitry 205, the example interface circuitry 210, the example data labeling circuitry 215, and the example data storage 220, and/or, more generally, the example data ranking circuitry 205, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example data ranking circuitry 205 of FIG. 2 may include one or more elements, processes, and/or devices in addition to, or instead of, those illustrated in FIG. 2, and/or may include more than one of any or all of the illustrated elements, processes, and devices.

The example interface circuitry 210 interfaces with an annotator. The example interface circuitry 210 presents the annotator with the data points identified as needing further annotation based on the ranked EMA statistics. The data points needing further annotation are presented through the interface circuitry to an annotator. An annotator may be an automated system, another AI system, a human annotator, or any other method for labeling a data point. The interface circuitry may be a communication pathway or a physical user interface. The annotator helps to classify the data points needing further annotation.

In some examples, the interface circuitry 210 is instantiated by programmable circuitry executing data review instructions and/or configured to perform operations such as those represented by the flowchart(s) of FIG. 3.

In some examples, the interface circuitry 210 includes means for interfacing. For example, the means for interfacing may be implemented by interface circuitry 210. In some examples, the interface circuitry 210 may be instantiated by programmable circuitry such as the example programmable circuitry 412 of FIG. 4. For instance, the interface circuitry 210 may be instantiated by the example microprocessor 500 of FIG. 5 executing machine executable instructions such as those implemented by at least blocks 702, 704 of FIG. 7. In some examples interface circuitry 210 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the interface circuitry 210 may be instantiated by any other combination of hardware, software, and/or firmware. For example, the interface circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the interface circuitry 210 of FIG. 2 is illustrated in FIG. 1, one or more of the elements, processes, and/or devices illustrated in FIG. 1 may be combined, divided, re-arranged, omitted, eliminated, and/or implemented in any other way. Further, the example data ranking circuitry 205, the example interface circuitry 210, the example data labeling circuitry 215, and the example data storage 220, and/or, more generally, the example data labeling circuitry 215 of FIG. 2, may be implemented by hardware alone or by hardware in combination with software and/or firmware. Thus, for example, any of the example data ranking circuitry 205, the example interface circuitry 210, the example data labeling circuitry 215, and the example data storage 220, and/or, more generally, the example interface circuitry 210, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example interface circuitry 210 of FIG. 2 may include one or more elements, processes, and/or devices in addition to, or instead of, those illustrated in FIG. 2, and/or may include more than one of any or all of the illustrated elements, processes, and devices.

The example data labeling circuitry 215 takes the annotation input from the example interface circuitry 210 and edits the existing data point of the dataset to modify the label associated with the data point.

In some examples, the data labeling circuitry 215 is instantiated by programmable circuitry executing data review instructions and/or configured to perform operations such as those represented by the flowchart(s) of FIG. 3.

In some examples, the data labeling circuitry 215 includes means for labeling data. For example, the means for labeling data may be implemented by data labeling circuitry 215. In some examples, the data labeling circuitry 215 may be instantiated by programmable circuitry such as the example programmable circuitry 412 of FIG. 4. For instance, the data labeling circuitry 215 may be instantiated by the example microprocessor 500 of FIG. 5 executing machine executable instructions such as those implemented by at least blocks 702, 704 of FIG. 7. In some examples data labeling circuitry 215 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the data labeling circuitry 215 may be instantiated by any other combination of hardware, software, and/or firmware. For example, the data labeling circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the data labeling circuitry 215 of FIG. 2 is illustrated in FIG. 1, one or more of the elements, processes, and/or devices illustrated in FIG. 1 may be combined, divided, re-arranged, omitted, eliminated, and/or implemented in any other way. Further, the example data ranking circuitry 205, the example interface circuitry 210, the example data labeling circuitry 215, and the example data storage 220, and/or, more generally, the example data labeling circuitry 215 of FIG. 2, may be implemented by hardware alone or by hardware in combination with software and/or firmware. Thus, for example, any of the example data ranking circuitry 205, the example interface circuitry 210, the example data labeling circuitry 215, and the example data storage 220, and/or, more generally, the example data labeling circuitry 215, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example data labeling circuitry 215 of FIG. 2 may include one or more elements, processes, and/or devices in addition to, or instead of, those illustrated in FIG. 2, and/or may include more than one of any or all of the illustrated elements, processes, and devices. The example data storage 220 is included in the data review circuitry 110 for the purposes of data storage and retrieval. The example data storage 220 may be instantiated as a database, files, a data structure, etc. The example data storage 220 is implemented by any memory storage device, and/or storage disc for storing data such as flash memory, magnetic media, optical media, etc. Furthermore, the data stored in the example data storage 220 can be in any data format such as binary data, comma delimited data, delimited data, structured query language (SQL) structures, image data, etc. The data storage accumulates the training loss obtained from the model training.

In some examples, the data storage 220 is instantiated by programmable circuitry executing data review instructions and/or configured to perform operations such as those represented by the flowchart(s) of FIG. 3.

In some examples, the data storage 220 includes means for storing data. For example, the means storing data may be implemented by data storage 220. In some examples, the data storage 220 may be instantiated by programmable circuitry such as the example programmable circuitry 412 of FIG. 4. For instance, the data storage 220 may be instantiated by the example microprocessor 500 of FIG. 5 executing machine executable instructions such as those implemented by at least blocks 702, 704 of FIG. 7. In some examples, the data storage 220 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the data storage 220 may be instantiated by any other combination of hardware, software, and/or firmware. For example, the data storage 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the data storage 220 of FIG. 1 is illustrated in FIG. 2, one or more of the elements, processes, and/or devices illustrated in FIG. 2 may be combined, divided, re-arranged, omitted, eliminated, and/or implemented in any other way. Further, the example data ranking circuitry 205, the example interface circuitry 210, the example data labeling circuitry 215, and the example data storage 220, and/or, more generally, the example data storage 220 of FIG. 2, may be implemented by hardware alone or by hardware in combination with software and/or firmware. Thus, for example, any of the example data ranking circuitry 205, the example interface circuitry 210, the example data labeling circuitry 215, and the example data storage 220, and/or, more generally, the example data storage 220, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example data storage of FIG. 2 may include one or more elements, processes, and/or devices in addition to, or instead of, those illustrated in FIG. 1, and/or may include more than one of any or all of the illustrated elements, processes, and devices.

A flowchart representative of example machine readable instructions, which may be executed by programmable circuitry to implement and/or instantiate the data review circuitry 110 of FIG. 1 and/or representative of example operations which may be performed by programmable circuitry to implement and/or instantiate the data review circuitry 110 of FIG. 1, is shown in FIG. 3. The machine readable instructions may be one or more executable programs or portion(s) of one or more executable programs for execution by programmable circuitry such as the programmable circuitry 412 shown in the example processor platform 400 discussed below in connection with FIG. 4 and/or may be one or more function(s) or portion(s) of functions to be performed by the example programmable circuitry (e.g., an FPGA) discussed below in connection with FIGS. 5 and/or 6. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 3, many other methods of implementing the example data review circuitry 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed, instantiated, and/or performed by programmable circuitry to adjust a subset of data from a database including a full dataset. The subset is selected based on statistical analysis to determine which candidates from the full dataset are noisy label sample candidates and recommends the noisy label sample candidates to an annotator. The annotator then adjusts the subset of data by annotating the noisy label sample candidates to correct the noisy label.

The example machine-readable instructions and/or the example operations 300 of FIG. 3 begin at block 302, at which the example data ranking circuitry 205 accesses the stored dataset used for model training in the artificial intelligence system. The dataset may be stored in the example data storage 220.

At block 304, the data ranking circuitry 205 decomposes the total training loss associated with the model training into a label-level loss to accommodate different minimum units of labeling noise in different computer vision tasks. To accomplish this decomposition, rules are imposed depending on the type of task associated. For a classification task, the instantaneous loss is used, and no decomposition is performed because the label is of an image. For an object detection task, the instantaneous loss is decomposed into the sum of the classification loss for a bounding box label and the regression loss to fit the bounding box location. The decomposed losses are tracked by the data ranking circuitry 205 to detect the noise in the class label and position of the bounding box. For a segmentation task, the instantaneous loss is decomposed into the pixel level classification loss. Due to the memory cost of maintaining the loss dynamics in the pixel level, the pixels are grouped using superpixels.

Once the training loss is decomposed, the data ranking circuitry 205 calculates the exponential moving average (EMA) statistics of the decomposed loss (block 306). The EMA statistics are the computed weighted mean of all the previous data points considered with the weights decaying exponentially. The aggregate EMA statistics are stored in data storage 220.

Once the aggregate statistics are calculated and stored, the EMA statistics are utilized to rank and sort associated data points (block 308). For example, data points may be sorted based on descending numerical order of the statistics assigned to each data point. The noisy label sample data points (e.g., a subset of the data points chosen as a set number of data points with the highest/greatest loss, a percentage of data points with the highest/greatest loss, etc.) are ranked and sorted into a group as candidates for annotation (block 310). The sorted and ranked data points are stored in data storage 220, with the EMA statistics paired with labels from the database.

Continuing with the flowchart of FIG. 3, at block 312, the interface circuitry 210 requests an annotator to annotate/relabel noisy label sample data point candidates. The annotator may be an automated system, another artificial intelligence system, or a human annotator.

Once the annotator is prompted for annotation and supplies an annotation, the annotation of the noisy label sample data points is stored in data storage 220. At block 314, the example data labeling circuitry 215 accesses the annotation and associated data. The data labeling circuitry 215 then adjusts the data label based on the annotation (block 316). The adjusted data is then stored into data storage 220 by the data labeling circuitry 215 (block 318).

FIG. 4 is a block diagram of an example programmable circuitry platform 400 structured to execute and/or instantiate the example machine-readable instructions and/or the example operations of FIG. 3 to implement the data review circuitry 110 of FIG. 1. The programmable circuitry platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a digital video recorder, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAs, microprocessors, CPUs, GPUs, DSPs, and/or microcontrollers from any desired family or manufacturer. The programmable circuitry 412 may be implemented by one or more semiconductor based (e.g., silicon based) devices. In this example, the programmable circuitry 412 implements the data ranking circuitry 205, the interface circuitry 210, and data labeling circuitry 215.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 432, which may be implemented by the machine readable instructions of FIG. 3, may be stored in the mass storage device 428, in the volatile memory 414, in the non-volatile memory 416, and/or on at least one non-transitory computer readable storage medium such as a CD or DVD which may be removable.

FIG. 5 is a block diagram of an example implementation of the programmable circuitry 412 of FIG. 4. In this example, the programmable circuitry 412 of FIG. 4 is implemented by a microprocessor 500. For example, the microprocessor 500 may be a general-purpose microprocessor (e.g., general-purpose microprocessor circuitry). The microprocessor 500 executes some or all of the machine-readable instructions of the flowcharts of FIG. 3 to effectively instantiate the circuitry of FIG. 2 as logic circuits to perform operations corresponding to those machine readable instructions. In some such examples, the circuitry of FIG. 1 is instantiated by the hardware circuits of the microprocessor 500 in combination with the machine-readable instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowcharts of FIG. 3.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating-point operations. In yet other examples, the AL circuitry 516 may include first AL circuitry that performs integer-based operations and second AL circuitry that performs floating-point operations. In some examples, the AL circuitry 516 may be referred to as an Arithmetic Logic Unit (ALU).

The registers 518 are semiconductor-based structures to store data and/or instructions such as results of one or more of the operations performed by the AL circuitry 516 of the corresponding core 502. For example, the registers 518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure, such as by being distributed throughout the core 502 to shorten access time. The second bus 522 may be implemented by at least one of an I2C bus, a SPI bus, a PCI bus, or a PCIe bus.

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMS s), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages.

The microprocessor 500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 500, in the same chip package as the microprocessor 500 and/or in one or more separate packages from the microprocessor 500.

FIG. 6 is a block diagram of another example implementation of the programmable circuitry 412 of FIG. 4. In this example, the programmable circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 500 of FIG. 5 described above (which is a general purpose device that may be programmed to execute some or all of the machine readable instructions represented by the flowchart(s) of FIG. 3 but whose interconnections and logic circuitry are fixed once fabricated), the FPGA circuitry 600 of the example of FIG. 6 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 3. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 3. As such, the FPGA circuitry 600 may be configured and/or structured to effectively instantiate some or all of the operations/functions corresponding to the machine readable instructions of the flowchart(s) of FIG. 3 as dedicated logic circuits to perform the operations/functions corresponding to those software instructions in a dedicated manner analogous to an ASIC. Therefore, the FPGA circuitry 600 may perform the operations/functions corresponding to the some or all of the machine readable instructions of FIG. 3 faster than the general-purpose microprocessor can execute the same.

In the example of FIG. 6, the FPGA circuitry 600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain a binary file, which may be implemented by a bit stream, data, and/or machine-readable instructions, to configure the FPGA circuitry 600, or portion(s) thereof. In some such examples, the configuration circuitry 604 may obtain the binary file from a user, a machine (e.g., hardware circuitry (e.g., programmable, or dedicated circuitry) that may implement an Artificial Intelligence/Machine Learning (AI/ML) model to generate the binary file), etc., and/or any combination(s) thereof). In some examples, the external hardware 606 may be implemented by external hardware circuitry. For example, the external hardware 606 may be implemented by the microprocessor 500 of FIG. 5.

The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations/functions that may correspond to at least some of the machine readable instructions of FIG. 3 and/or other desired operations. The logic gate circuitry 608 shown in FIG. 6 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations/functions. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example dedicated operations circuitry 614. In this example, the dedicated operations circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the programmable circuitry 412 of FIG. 4, many other approaches are contemplated. For example, FPGA circuitry may include an on-board CPU, such as one or more of the example CPU 620 of FIG. 5. Therefore, the programmable circuitry 412 of FIG. 4 may additionally be implemented by combining at least the example microprocessor 500 of FIG. 5 and the example FPGA circuitry 600 of FIG. 6. In some such hybrid examples, one or more cores 502 of FIG. 5 may execute a first portion of the machine readable instructions represented by the flowchart(s) of FIG. 3 to perform first operation(s)/function(s), the FPGA circuitry 600 of FIG. 6 may be configured and/or structured to perform second operation(s)/function(s) corresponding to a second portion of the machine readable instructions represented by the flowcharts of FIG. 3, and/or an ASIC may be configured and/or structured to perform third operation(s)/function(s) corresponding to a third portion of the machine readable instructions represented by the flowcharts of FIG. 3.

It should be understood that some or all of the circuitry of FIG. 1 may, thus, be instantiated at the same or different times. For example, same and/or different portion(s) of the microprocessor 500 of FIG. 5 may be programmed to execute portion(s) of machine-readable instructions at the same and/or different times. In some examples, same and/or different portion(s) of the FPGA circuitry 600 of FIG. 6 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 500 of FIG. 5 may execute machine readable instructions in one or more threads executing concurrently and/or in series. In some examples, the FPGA circuitry 600 of FIG. 6 may be configured and/or structured to carry out operations/functions concurrently and/or in series. Moreover, in some examples, some or all of the circuitry of FIG. 1 may be implemented within one or more virtual machines and/or containers executing on the microprocessor 500 of FIG. 5.

In some examples, the programmable circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the programmable circuitry 412 of FIG. 4, which may be in one or more packages. For example, the XPU may include a CPU (e.g., the microprocessor 500 of FIG. 5, the CPU 620 of FIG. 6, etc.) in one package, a DSP (e.g., the DSP 622 of FIG. 6) in another package, a GPU in yet another package, and an FPGA (e.g., the FPGA circuitry 600 of FIG. 6) in still yet another package.

From the foregoing, it will be appreciated that example systems, apparatus, articles of manufacture, and methods have been disclosed that improve dataset quality and subsequently the model quality of artificial intelligence systems. Disclosed systems, apparatus, articles of manufacture, and methods improve the efficiency of using a computing device by processing and analyzing large datasets to reduce the errors adversely impacting AI performance. Additionally, an improved dataset quality leads to faster convergence, meaning the model requires fewer training iterations to achieve the desired level of accuracy and thus reduces the training time. Further, using training loss statistics carries an advantage of being applicable to any training model and learning algorithm without the need for modifications during training. Disclosed systems, apparatus, articles of manufacture, and methods are accordingly directed to one or more improvement(s) in the operation of a machine such as a computer or other electronic and/or mechanical device.

<Example paragraphs corresponding to the final claims will be added once claims are approved>

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
determine a first training loss associated with a first data point of training data for training a machine learning model;
determine a second training loss associated with a second data point of the training data;
rank the training data based on aggregate statistics of the first and second training losses;
select, based on the rank, the first data point for annotation; and
modify an existing label of the first data point based on the annotation.

2. The apparatus of claim 1, wherein the programmable circuitry is to determine the aggregate statistics on loss values determined based on a decomposition of the first training loss.

3. The apparatus of claim 2, wherein the aggregate statistics include an exponential moving average.

4. The apparatus of claim 1, wherein the training data is image recognition data.

5. The apparatus of claim 1, wherein the programmable circuitry is to classify the data points into data points with noisy labels and data points with non-noisy labels.

6. The apparatus of claim 5, wherein the programmable circuitry is to classify the data points as data points with noisy labels based on the aggregate statistics associated with the data points with noisy labels compared with the aggregate statistics associated with the data points with non-noisy labels.

7. The apparatus of claim 1, wherein the programmable circuitry is to provide the selected first data point to a human reviewer for the annotation of the first data point.

8. A non-transitory computer readable storage medium comprising instructions to cause programmable circuitry to at least:
determine a first training loss associated with a first data point of training data for training a machine learning model;
determine a second training loss associated with a second data point of the training data;
rank the training data based on aggregate statistics of the first and second training losses;
select, based on the rank, the first data point for annotation; and
modify an existing label of the first data point based on the annotation.

9. The non-transitory computer readable storage medium of claim 8, wherein the instructions, when executed, cause the programmable circuitry to determine the aggregate statistics on loss values determined based on a decomposition of the first training loss.

10. The non-transitory computer readable storage medium of claim 9, wherein the aggregate statistics include an exponential moving average.

11. The non-transitory computer readable storage medium of claim 8, wherein the training data is image recognition data.

12. The non-transitory computer readable storage medium of claim 8, wherein the instructions, when executed, cause the programmable circuitry to classify the data points into data points with noisy labels and data points with non-noisy labels.

13. The non-transitory computer readable storage medium of claim 12, wherein the instructions, when executed, cause the programmable circuitry to classify the data points as data points with noisy labels based on the aggregate statistics associated with the data points with noisy labels compared with the aggregate statistics associated with the data points with non-noisy labels.

14. The non-transitory computer readable storage medium of claim 8, wherein the instructions, when executed, cause the programmable circuitry to provide the selected first data point to a human reviewer for the annotation of the first data point.

15. A method comprising:
determining a first training loss associated with a first data point of training data for training a machine learning model;
determining a second training loss associated with a second data point of the training data;
ranking the training data based on aggregate statistics of the first and second training losses;
selecting, based on the ranking, the first data point for annotation; and
modifying an existing label of the first data point based on the annotation.

16. The method of claim 15, further including determining the aggregate statistics on loss values determined based on a decomposition of the first training loss.

17. The method of claim 16, wherein the aggregate statistics include an exponential moving average.

18. The method of claim 15, wherein the training data is image recognition data.

19. The method of claim 15, further including classifying the data points into data points with noisy labels and data points with non-noisy labels.

20. The method of claim 19, further including classifying the data points as data points with noisy labels based on the aggregate statistics associated with the data points with noisy labels compared with the aggregate statistics associated with the data points with non-noisy labels.
